(19) United States
(12) Patent Application Publication
(10) Pub. No.: US 2019/0131924 A1
(43) Pub. Date: May 2, 2019

(54) HIGH EFFICIENT SPACE SHELL SOLAR ENERGY UNIT

(71) Applicants: HUAZI LIN, Richmond Hill (CA); W&E International (Canada) Corp., Richmond Hill (CA)

(72) Inventors: Huazi LIN, Richmond Hill (CA); Yuanhao LIN, Richmond Hill (CA)

(21) Appl. No.: 16/089,652

(22) PCT Filed: Mar. 29, 2017
(86) PCT No.: PCT/CA2017/000068

§ 371 Date: Sep. 28, 2018

(30) Foreign Application Priority Data
Mar. 30, 2016 (CA) PCT/CA2016/000085
Mar. 30, 2016 (CA) PCT/CA2016/000086

(51) Int. Cl. H02S 40/44; F24S 10/50; F24S 70/10; F24S 70/225; F24S 70/16; F24S 70/30

(52) U.S. Cl. CPC H02S 40/44; F24S 10/50; F24S 70/30; F24S 70/225; F24S 70/16; F24S 70/10

(57) ABSTRACT

This disclosure provides a high efficient space shell solar energy unit. The unit used at least two different solar energy absorbing materials for absorb solar energy from different spectrum of sunlight. The absorbing materials comprising at least one transparent solar energy absorbing material absorbed solar energy mainly from ultraviolet ray and/or infrared ray of sunlight. The unit can be new manufactured or improved from existing low-E glass, PV Panel and thin film cell.

### TECHNICAL FIELD

This disclosure relates to solar energy applications. This disclosure specially relates to the high efficient space shell solar energy unit. The unit uses at least two different solar energy absorbing materials to absorb solar energy from different spectrum bands of sunlight. At least one transparent solar energy absorbing material is used to absorbing solar energy mainly from ultraviolet ray and/or infrared ray.

### BACKGROUND

This application claimed the priority applications of PCT/CA/2016/000085 and PCT/CA2016/000086 which is hereby incorporated by reference.

We are entering a new energy era. Solar energy will be the key and the most important energy in the new energy era. There are many solar energy application products are developed and in operation. More R&D is going to improve the existing products and try to achieve a high efficient solar energy unit and system.

What is an idea high efficient solar energy unit? How to achieve a high efficiency?

The energy of sunlight is mainly in three spectrum regions: ultraviolet, visible and infrared. There are three solar energy application areas: solar thermal, solar electricity and lighting. The idea high efficient solar energy unit may have most of the following features:
1. The unit not only can transfer solar to electricity, but also can transfer solar to heat, and provide both solar electricity and solar heat. It is a solution to Integrate solar electricity and solar thermal in one unit.
2. The unit can absorb solar energy from three main solar energy regions of solar spectrum. At least two solar energy absorbing materials may require.
3. Local generation, local storage and local consumption to reduce the transmission losses. The space shell solar energy unit may be a solution.
4. It is best to take into account of the lighting of the space. It may be a solution that translucent unit including at least one transparent solar energy absorbing material.
5. Can be adapted to the local weather and economic statues. This may mean the time is over that to use one single product for all areas. Solar industry needs to enter into the time of precision solar energy industry.

Based on above analysis, most of the solar application products in the market have some rooms for improvement. Following are the examples:

The panels of PV cell and thin film cell are most popular solar electricity products in market now. But their efficiency is less than 30%. 70% solar energies are wasted.

The central power stations based on solar cell technologies further need to add energy loss in transmission.

The single solar thermal products have very high energy heat efficiency, but less flexibility in use.

Some integrated solar electricity and solar thermal products are not completely idea, du to the elements are not high efficiency.

There are solar energy saving glasses, e.g. low emissivity glass (low-E glass), or the like, e.g. heat insulation glass. They are insulating glasses placed with solar thermal coating. Their energy efficiency also can be increased in some areas, after consider the local weather conditions.

Therefore there is room to improve the existing products or to develop new product. In our prior art of PCT/CA2013/000856 and the priority applications PCT/CA/2016/000085 and PCT/CA2016/000086we, we have introduced the reasons, ideas, steps and solutions. Here will not repeat them again.

The purpose of this disclosure is to provide a high efficient solar energy unit to be used as space shell. The unit can also be used as a basic element of a central energy station in a community. The space shell means an object covers the space fully or partially and separates the space from surroundings. The examples of the space are the buildings and transportation devices. The examples of the building include industrial, commercial and residential buildings. The transportation device may be selected from a group of: a road transportation device, a rail way transportation device, a maritime transportation device; an air transportation device. The examples of the shell unit include window, door, roof, wall and their combinations of buildings and transportation devices.

The basic idea and technical route of this disclosure is as following:

The unit comprises at least two separable or electrically insulated solar energy materials. The unit can absorb solar energy from three main spectrum bans of sunlight: ultraviolet ray (UV), visible light ray (VL) and infrared ray (IR). The unit needs to covert solar energy to electricity first and as much as possible. Then the unit convert the remained solar energy to heat. The unit can be used as space shell, so it not only can provide solar electricity, but also can heat and cool the space by received solar energy locally. At least one of said two absorbing materials is transparent. So the sunlight can partially pass through the first absorbing material and reach second one. It is better the sunlight can get into the space for lighting. The unit takes account of the weather situations in different areas. The new technology not only can produce new products, but also can be used to renovate existing solar energy products.

### SUMMARY

The present disclosure provides a high efficient space shell solar energy unit in claim 1. The unit comprises: at least two different solar energy absorbing materials for absorb solar energy; said absorbing materials comprising at least one transparent solar energy absorbing material absorbed solar energy mainly from ultraviolet ray and/or infrared ray of sunlight; carrier material for arranging said absorbing materials, comprising at least one transparent said carrier material and two or three said carrier materials parallel connected and separated by air gap; and a fluid channel for transferring absorbed solar heat for use.

The solar energy absorbing material of above mentioned unit can be selected from a group of: a translucent coating material for low-E glass; a solar heat absorbing material for heat insulation glass; a solar thermal material for solar thermal products; a solar cell material converted solar energy to electricity mainly from visible light and comprising semiconductor (e.g. silicon) and said solar cell also can convert solar energy to thermal; an organic solar energy coat; a transparent solar to electricity material converted received solar energy to electricity mainly from the Ultraviolet ray and/or infrared ray of the sunlight; a transparent solar to thermal material converted received solar energy to thermal mainly from the infrared ray and/or ultraviolet ray of the sunlight and a smart film based on Polymer Dispersed Liquid Crystals (PDLCs) and required power supply.

The unit according to claim 1, wherein said smart film comprises a control device comprising one or more selected from a group of: a transformer; a photometer; a timer and a controller.

The unit according to claim 1, wherein said carrier material is selected from a group of: one transparent carrier material; two carrier materials parallel connected and separated by air gap; three carrier materials parallel connected and separated by air gap.

When the unit mentioned above comprises a solar to electricity material, the further comprises an electricity connecting device for transferring said electricity for use. The device comprising one or more selected from a group of: a DC/AC converter, a transformer, a photometer and a controller.

The unit mentioned above wherein said carrier material may select from a group of: an insulating glass; a glass; a polymer; a film/foil; a surface of an element of the space shell able to receive sunlight; an insulating glass, or double glazing; a heat insulation glass; and a solar panel or thin film based on solar cells.

The unit mentioned above, wherein said solar fluid channel comprising one or more selected from a group of: air surround solar thermal absorbing material; a liquid channel; a gas channel; a fan; a pump; and a controller for transferring said fluid.

The unit mentioned above, wherein said two solar energy absorbing materials are arranged on two sides of one transparent material; and wherein said transparent material is removeably inserted in a slot located in a insulating glass.

The unit mentioned above, comprising a frame in the space shell for receiving said unit, and wherein said unit can be removed from said frame; and wherein said carrier material with solar energy absorbing material can be detached from said unit for replacing and repairing. This is because the operation live time of the solar energy absorbing material is shorter than the glass.

The unit mentioned above, wherein said solar absorbing materials and carrier materials are integrated in a form selected from a group of: a laminated unit; and an assumable unit, wherein said solar absorbing materials and carrier materials separated by separator and air gap.

The unit according to claim 1, further comprising one or more selected from a group of: a heat insulation material arranged at the back of the unit; a phase change material arranged under the unit for storing heat and limiting the working temperature of the unit; and a fluid channel for transferring the absorbed heat.

The present application also provides a space and space share comprises a high efficient space shell solar energy unit comprising: at least two different solar energy absorbing materials for absorb solar energy; said absorbing materials comprising at least one transparent solar energy absorbing material absorbed solar energy mainly from ultraviolet ray and/or infrared ray of sunlight; at least one transparent carrier material for arranging said absorbing materials; and a fluid channel for transferring absorbed solar heat for use.

Other aspects and features of the present disclosure will become apparent to those ordinarily skilled in the art up review of the following description of specific embodiments of the invention in conjunction with the accompanying figures. They may include in the claims of this application.

### BRIEF DESCRIPTION OF THE DRAWINGS

FIG. 1 is a schematic diagram illustrating the images and symbols of the components of the solar energy unit;

FIG. 2 is a schematic diagram illustrating a high efficient solar energy unit;

FIG. 3 is a schematic diagram illustrating a high efficient space shell solar energy unit

FIG. 4 is a schematic diagram illustrating a renovated Low-E glass or heat insulation glass

FIG. 5 is a schematic diagram illustrating a light adjustable solar energy unit.

### DETAILED DESCRIPTIONS

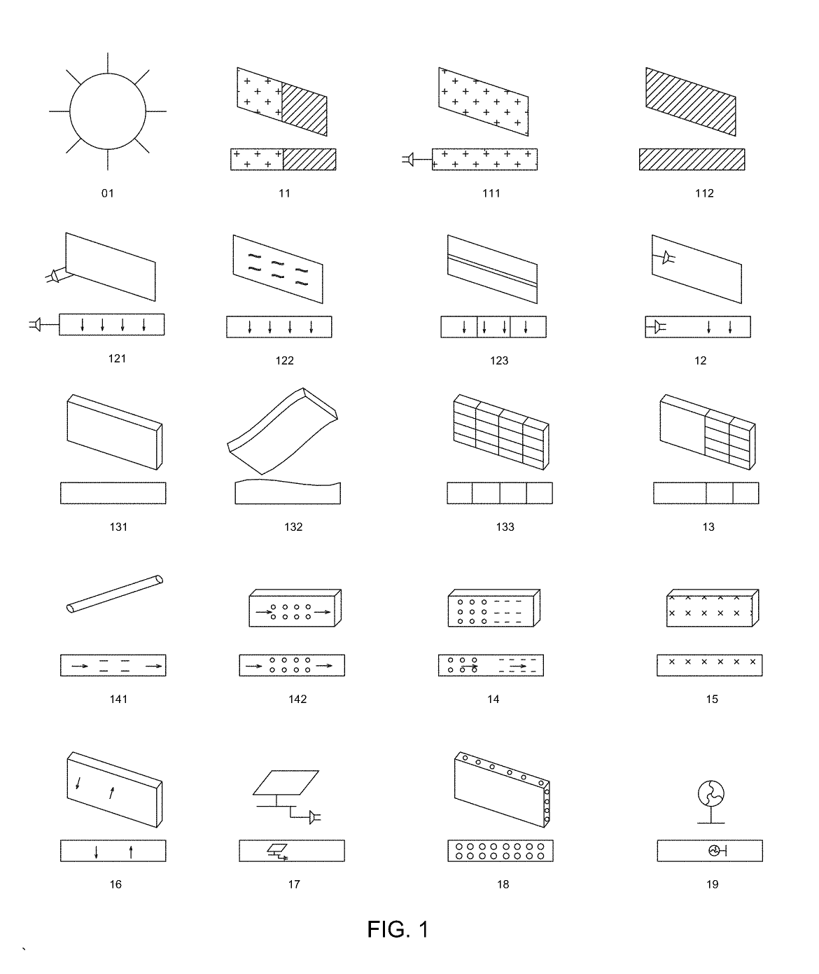

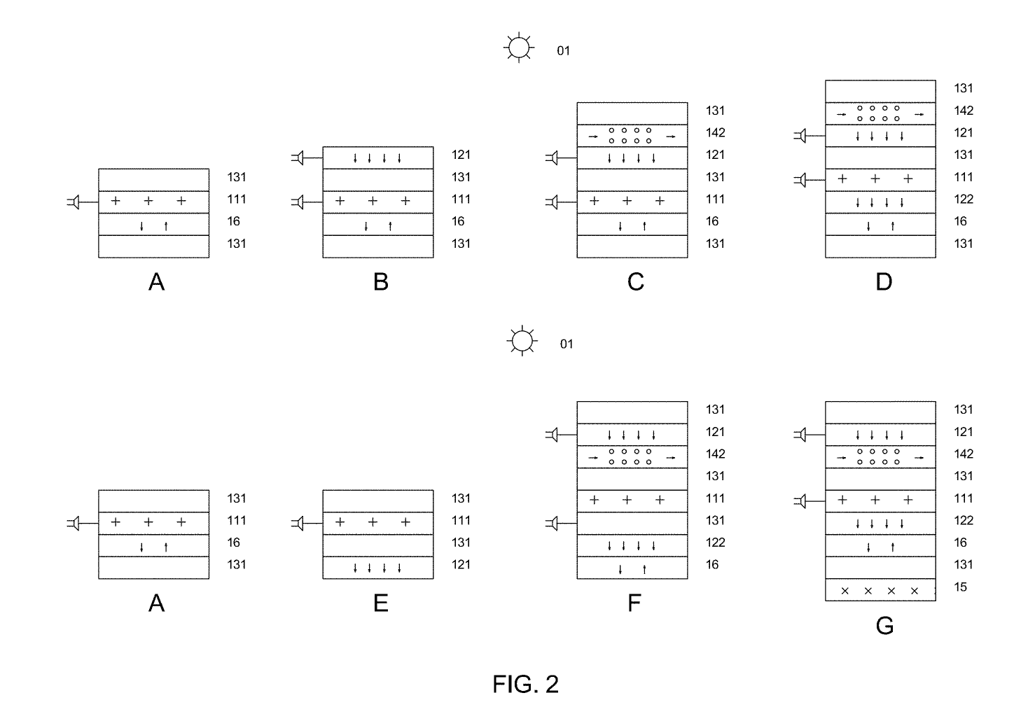

Following are the detailed descriptions of the examples how a high efficient solar energy unit can be built. The examples also explain how to modify and upgrade existing solar energy units and increase their efficiency by adding new elements. Some of the claimed materials in this disclosure are very thin pieces such as coating and thin film etc. Some of them are transparent or translucent. It is very difficult to draw and identify them in the drawings. We first defined the images and symbols of the elements in FIG. 1. The drawings in FIG. 2 will use the symbols to present the components of the unit. The introductions of the components are for all descrosure.

Refer to FIG. 1: FIG. 1 provides the components of the claimed unit and their introduction, images and symbols for identify those elements easies in the following drawings and descriptions. They are as follows:

01: Sunlight, the resource of all solar energy.

11: Solar energy absorbing material, that covert solar energy to photo-electricity and photo thermal or to solar thermal only.

111: Solar cell material converted solar energy to electricity mainly based on solar cells. The solar cell material also generates solar heat. Their examples are PV cell and thin film cell that are used popularly. The solar cell materials usually comprise semi-conductor (e.g. silicon) material. The solar cells mainly absorb visible ray. Solar cells are not the transparent solar energy material. The cell, module and panel of solar cell material are translucent or opaque.

112: Solar thermal material converted solar energy to thermal.

121: Transparent solar electricity material converted solar energy to electricity mainly from ultraviolet ray and/or inflated ray.

122: Transparent solar thermal material converted solar energy to heat mainly from inflated ray and/or ultraviolet ray.

123: PDLCs for smart film or light switchable film. The solar to thermal material also comprises Polymer Dispersed Liquid Crystals (PDLCs). Smart film or Switchable Film is made of Polymer Dispersed Liquid Crystal (PDLCs). It is a product that is capable of adjusting light transmission between transparent and opaque by a controlled electric field. Because it can be full transparent, so in this disclosure, a smart film also traded as a transparent solar thermal absorbing material.

Note: There are several kinds of transparent solar energy absorbing materials. The common feature of this material is that they absorber solar energy mainly from ultraviolet ray or infrared ray or both. In this disclosure, the transparent solar absorbing material comprises the transparent solar to electricity material, the transparent solar to thermal material and PDLCs. The transparent solar energy absorbing materials may include organic solar energy absorbing coat.

13. Carrier material: The carrier material is for arrange and support the materials. It also isolates and/or insulate the solar energy absorbing materials and with other material or air. The carrier material may be transparent, translucent or opaque. The examples of the transparent carrier material comprise transparent glass, polymer and film etc. The popular translucent carrier material is transparent material applied with translucent coating. The space shell elements are also the carrier material. They may comprise the material of roofs, walls, windows, doors of the buildings and transportation devices.

131: Glass and hard transparent material.

132: Film and soft transparent material.

133: Surface materials of the space shell.

14: Fluid channel: the fluid channel is a channel of liquid or gas (e.g. air) for transferring absorbed solar heat. The front or back surface without heat insulation is an air channel too for air to transfer the heat. The fluid channel may selectively comprise: driving device (e.g. pump and fan), sensor and controller to force and direct the flow of the fluid for heat transferring.

141: Liquid channel.

142: Gas (e.g. air) channel.

15: Air gap

16: Reflect material.

17: Electric connecting device: it is a device for connecting the solar electricity material to transfer said electricity for use or to connect two solar electricity materials. The electricity connecting device may selectively comprise: connector, switcher, DC/AC converter, transformer and controller.

18: Heat insulation material.

Refer to FIG. 2, an exemplary high efficient solar energy unit illustrated with unit symbols as shown in FIG. 1. In FIG. 2, the unit A comprises a glass or transparent film 131, a reflect material 16, a solar to electricity material 111 that is solar cell, and a cover of glass or transparent film, second 131. The solar cell material 111 may one layer or more layers. The key point is that the cell contains silicon and mainly absorbs solar energy from visible ray. A case is a typical arrangement of popular used solar panel or thin film solar cell in market. To increase the efficiency of the unit, we may add a transparent solar to electricity material 121 on the top of the unit A. For example, to apply a coating 121 on the front glass 131 of the laminated unit A to generate more electricity. This is B case of FIG. 1. To get the solar heat absorbed by unit B, we can add an air gap or air channel 142 above 121 and under a third transparent material 131. The channel 142 may comprises a fun or pump 19 for transferring heat including power supply and controller. This is shown in C of FIG. 1. Furthermore, to increase the solar thermal efficiency, a transparent solar thermal absorbing material 122 may be added in between of 111 and 16. The materials in between of first transparent material 131 and second 131 can be laminated in one unit. We even can put 121 under second 131 for laminating. This is the case D of FIG. 1. The unit D needs a frame (not shown in FIG. 1) for assembling the unit. When sunlight 01 shin on the unit D, the light passes through third 131 and 142, the transparent solar electric material 121 absorbs first part of solar energy mainly from UV ray and converts to electricity. The electricity transferred for use through an electricity connecting device (not shown in FIG. 2). The remained light passes 131 and arrives at 111, the solar cell of 111 absorbs solar energy mainly from visible ray of the sunlight and converts it to electricity too for use. The solar thermal absorbing material 122 absorbs the solar energy mainly from infrared ray of the sunlight and converts it to heat. The reflect material 16 reflects all the sunlight arrives at its surface and repeat the processing at a reverse direction to further increase the solar energy efficiency of the sunlight.

It is not necessary to arrange the material in FIG. 1 in the order as shown in FIG. 1. The order of the material can be changed according to the engineering situation. For example, 142 and 121 can change the locations each other in C case. The coating 121 can be applied on thirs transparent material 131 and above the fluid channel 142. In this case, a glass with a transparent solar electricity coating can be easily add to an existing PV panel in field to increase the panel's efficiency. It is also not necessary the materials in FIG. 1 to laminated. For example, in the case C, the first transparent material 131 and second transparent material 131 can be an insulating glass

It is not necessary all the materials in D of FIG. 1 need to be included in one unit. We can increase the efficiency of the unit by adding any one of the solar energy absorbing materials 121 and 122. For example, in case D of FIG. 2, we replace the reflecting material 16 by solar to thermal material 122 to get a translucent solar electric and thermal unit for heating and lighting the space. The case F comprises 131-121-142-131-111-131-122-16 is a modification version of D. In case G, we add a heat insulation 15 at the back of a modified high efficient solar energy unit to be used for roof or wall of a space in cool weather area. The heat insulation material 15 also can be replaced by a phase change material arranged under the unit for storing heat and limiting the working temperature of the unit. Sometime the phase change material comprises fluid channel.

We may provide more modified samples to meet the different economy and weather situations. All of the units in FIG. 2 comprise at least two different solar energy absorbing materials, and said solar energy absorbing materials comprising at least one transparent solar energy absorbing material absorbed solar energy mainly from ultraviolet ray and/or infrared ray.

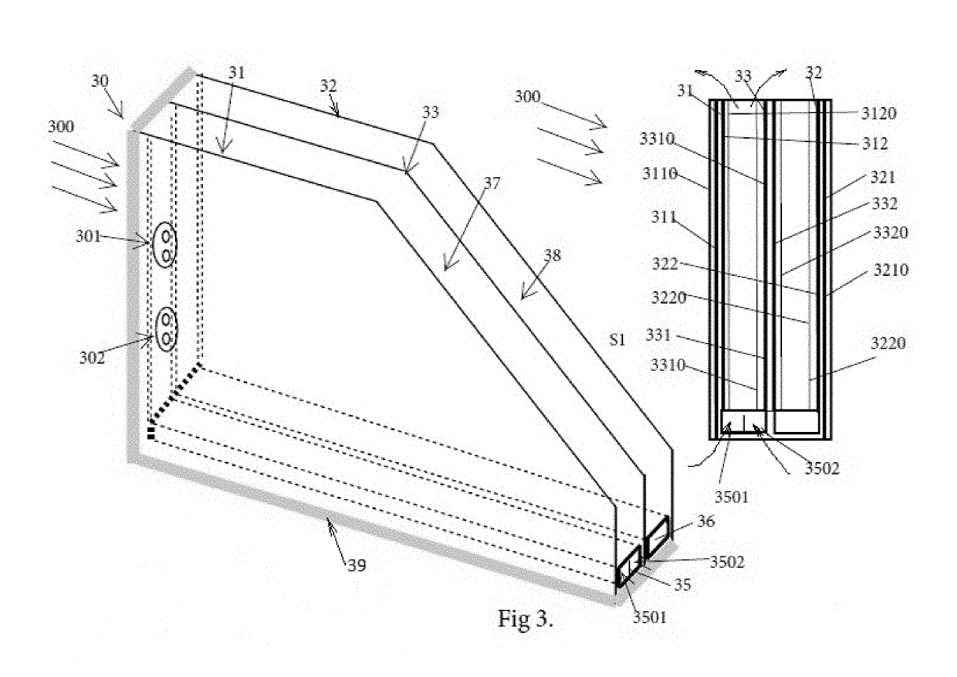

Refer to FIG. 3 an exemplary high efficient solar energy unit 30 is illustrated in vertical section view.

The unit 30 may have one transparent carrier material 31 (e.g. glass) having first side 311 and second side 312. The two different solar absorbing materials 3110 and 3120, claimed in claim 1, can be arranged on both sides of the unit 30. The rules are provided bellow.

The unit may have two transparent carrier materials 31 and 32. The material 32 (e.g. glass too) has first side 321 and second side 322. The two different solar absorbing materials, claimed in claim 1, can be arranged on any two sides selected from the four sides of the unit 30. The rules are same as the rules provided bellow. But usually the two glass unit has a spacer (35+36) to separate the two glasses 31 and 32. So the solar energy materials 3120 and 3220, claimed in claim 1, are applied on the sides 312 and 322 for protection reason.

The unit 30 can have three transparent materials (e.g. glasses too) 31, 32 and 33. The glass 33 has the first side 331 and second side 332. The two different solar absorbing materials, claimed in claim 1, can be arranged on any two sides selected from the six sides of the unit 30. They may two materials selected from the group of 3110, 3120, 3210, 3220, 3310 and 3320. The rules are same as the rules mentioned bellow. In this case, the spacer is 35 or 36, here is 35, may be also is a fluid channel for the fluid 3501 and 3502 to transfer the solar heat for space heating and cooling. When the solar energy absorbing material comprising one solar to electricity material (e.g. solar cell, transparent solar to electricity material and a smart film etc.) the electricity connecting device 301 will pick up the solar electricity for use. If the solar energy absorbing material comprises two solar to electricity materials (e.g. solar cell, transparent solar to electricity material and a smart film etc.) the electricity connecting device 301 and 302 will pick up the solar electricity respectively for use. The electricity connecting device 301 and 302 may comprise one or more selected from a group of a DC/AC converter, a DC/AC converter, a transformer, a photometer and a controller. If the voltages of the two solar electricity materials are different, a voltage adapter may also require.

Following are some rules that the unit 30 needs to follow: a. The solar to electricity material is at the front of sunlight 300 rather than the solar to thermal material. b. The Transparent solar absorbing material is at the front of sunlight rather than translucent and opaque material. c. The material absorbed more solar heat is arranged at the location closer to space in a cool weather area. It is reversed in a hot weather area. We'll use the unit 30 to descript how to a new high efficient solar energy space shell unit can be created or renovated by using an existing unit according to local weather and economy situation.

A frame 39 is for the assembled unit 30 to fix in the space shell of a space (not show in the Figure). The unit 30 can be removably received and removed from the slot of the frame. The glasses 31, 32 and 33 with their solar energy absorbing materials (if any) also can be detached from the unit 30 for the recoating, repairing or replacing the unit and/or the coatings on the glasses.

Furthermore to save the wasted glass and save the replace cost, the two claimed materials can be applied on the two sides of glass 33 in between the insulating glass formed by first glass 31 and second glass 32. A slot 333 in insulating glass removably receives the glass 32 including the solar energy absorbing materials 3310 and 3320. Other components such as the spacer 36, fluid channel 35, electricity connecting devices 301 and 302 are the same as mentioned in above samples. The operation processing is also similar as mentioned above. The difference is when the solar absorbing materials need to replace, the unit can be removed from the frame and the glass 33 in between the insulating glass can be removed and replaced. The most of the unit components are kept no change.

It is not necessary to limit the solar absorbing materials in two materials. For example, in FIG. 3, 3310 is a transparent solar to electricity material, 3320 is a solar cell material and 3230 is a translucent solar thermal material. When the sunlight 30 shine on the unit 30, the transparent solar to electricity material 3310 absorb the ultraviolet ray first and transfer to electricity to the connector 301. The solar cell material 3220 absorbs the visible light and converts it to electricity and delivered to the connector 302. The translucent solar thermal material. 3330 absorbs part of the rest sunlight and covert to solar heat. The last part of the light gets into the space room for lighting.

For all above mentioned samples, we also can remove the spacer(s) and replaced it/them by cross-linking material to manufacture the laminated units.

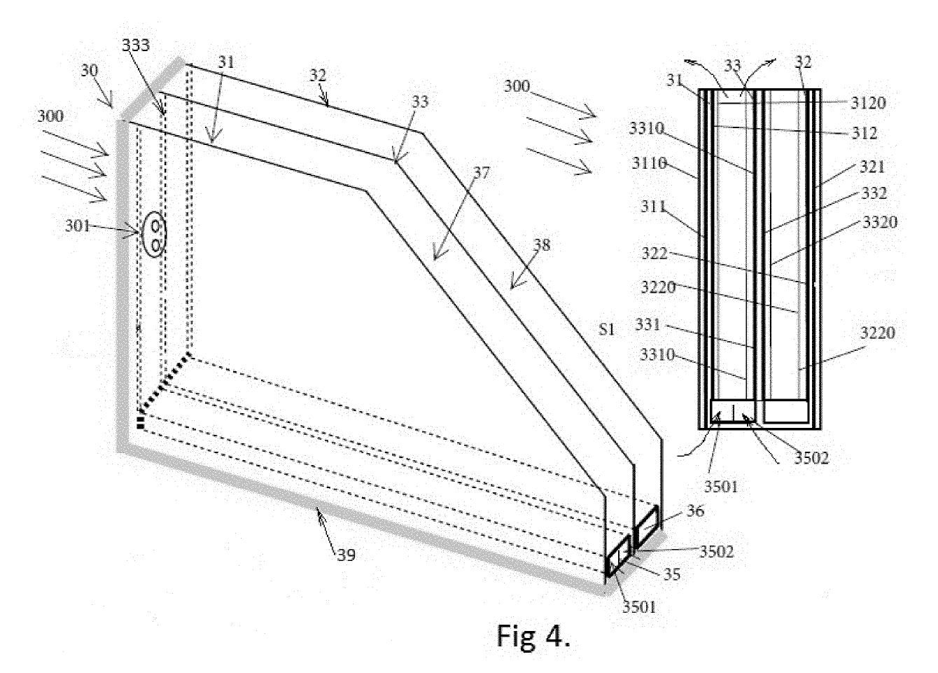

Refer to FIG. 4. an exemplary renovated Low-E glass or heat insulation glass is specially illustrated in vertical section view. This is considering that the low-E glasses and heat insulation glass are so popular in the existing buildings, especially in the curtain walls of the tower buildings and in the windows of the residential buildings.

The low-E glass and heat insulation glass comprise an insulating glass (hollow glass) and a heat absorbing material. The insulating glass has two parallel glasses that are separated and enclosed by a spacer to form a hollow space in between of the glasses. The spacer contains drier/desiccant to protect the coatings. The glasses are applied by transparent or translucent heat absorbing material on the two inner sides of the hollow space. The heat absorbing material usually is a coating. The heat absorbing material of low-E glass is low emissivity material. The heat absorbing material of the heat insulation glass is one of many different kinds of heat absorbing materials. Some of them may contain heat reflecting materials. The difference of the insulating glass and the heat insulation glass is whether or not there is the heat absorbing material on the glass. Under sunlight, all of them are solar heat absorbing materials. In this application they may be called as Low-E glass and/or heat insulation glass, either of them represents both of them and has same meaning. The main advantage of the heat insulation glass is that the first coat absorbs solar heat to reduce the solar heat getting into inner space of a building at day time or at hot weather. The second coat protects the heat transferring to outdoor at night time or cool weather. Usually the coating of the heat insulation glass is semi-transparent. The heat insulation curtain wall can replace the traditional wall. The disadvantages of the heat insulation glass and low-E glass are as following: The solar heat absorbed in the hollow space of the heat insulating glass has to be transferred either indoor or outdoor of the building by heat emission, conduction and convention. So from solar energy application point of view, the basic function of heat insulation glass is to block heat and store heat in its hollow space for transferring the heat to indoor and outdoor of the space. But at cool weather the temperature of the heat insulation glass is far higher than the temperature of the surrounding air and the air in door. When the two solar thermal absorbing materials are the same, the solar heat is mainly absorbed by the first coat. The solar heat absorbed at first coat is transferred to outdoor environment easier. This part of solar energy is wasted that should be used for heating building. At hot weather, the temperature in the space is the lowest temperature comparing to the temperatures of the heat insulating glass and the surrounding air of the space. The solar heat absorbed by the heat insulating glass is easier transferred to the inside of the space comparing to the outdoor environment. Therefore from the solar energy application point of view, the heat insulation glass is not the best solution. Some improving and renovating are required. One of the solutions is to replace them with new energy saving glass unit such as introduced in our patent applications. The more cost effective and energy saving way is to renovate the heat insulation glass and low-E glasses and increase their efficiency. Following are examples:

In FIG. 4, glasses 32 and 33 including the spacer 36 form an insulating glass 38. Translucent solar absorbing material is applied on the two inner sides 332 and 322. The two coatings are 3220 and 3320. Here the two coatings of the heat insulation glass can be treated as a solar thermal absorbing material.

To increase the solar energy efficiency and renovate a low-E glass or an insulation glass, according to the claimed technology of this application, following are the solutions and examples:

First we can simply add a transparent solar to electricity material (e.g. coating) 3310 on the side of 331 of the glass 33. The coating is connected to the electricity connecting device 301 for the generated electricity to be used. The coating 3310 also can be replaced by a transparent solar to thermal material to absorbing solar heat and keep more solar heat out of the space.

Second we can arrange a parallel glass 31 at the front of 38 toward sunlight 300. A new hollow space 37 is separated by a new added spacer 35. 35 may comprise a fluid channel 3501 with fan or pump. A frame 39 fixes all the parts in one unit 30. When sunlight shines, the heat absorbed by low-E glass 38 is blocked by glass 33 at the front. At hot season, the air in hollow space 37 can be pumped out for cooling the space S1. At cool season or night time, the heat in the space S1 will be blocked by the unit 30 that has stronger heat insulation feature compering to before renovation. We also can move the glass 31 to the back of the insulation glass 38. (not shown in FIG. 4) The feature is similar to the front case. It is depend on the local weather situation to add the glass 31 at front or back.

To increase the solar energy efficiency of the unit 30, the claimed solar energy absorbing materials can be arranged on the sides of the glasses 31, 32 and 33 except 3320 and 3220. Here the two coatings of the heat insulation glass can be treated as a solar thermal absorbing material. What we need to do is to apply a transparent solar to electricity coating 3120 on the side surface 312 of the glass 31. The generated electricity can be delivered to connecting 301 for use. The transparent solar to electricity coating 3120 can be replaced by the transparent solar thermal material. Both of them can help the unit 30 to absorb more solar energy.

The alternative way is that a transparent solar thermal material 3310 can be added on the side 331 of the glass 33. The solar to electricity material 3120 keeps no change. When sunlight shines, the coating 3120 absorbs the solar energy mainly from the ultraviolet ray and convers it to electricity. The electricity connecting device 301 picks up the generated electricity for use. The device 301 also selectively comprises connector, switcher, DC/AC convertor, controller etc. The coating 3310 absorbs the solar energy and coverts to heat mainly from infrared ray. The other sunlight passes through the two heat absorbing materials 3320 and 3220 and converts part of the energy to solar heat too. The light finally gets into the space S1 for lighting. The hat absorbed by the solar heat absorbing materials 3310, 3320 and 3220 will be stored in hollow spaces 37 and 38 for transmission. At the hot season, the air in hollow space 37 will be pumped out for cooling the space S1. At cool season or night time, the heat in the space S1 will be blocked by the unit 30 that has stronger heat insulation feature.

All the components of the electric connecting device and the fluid channel can be used in above cases. They do not repeat again.

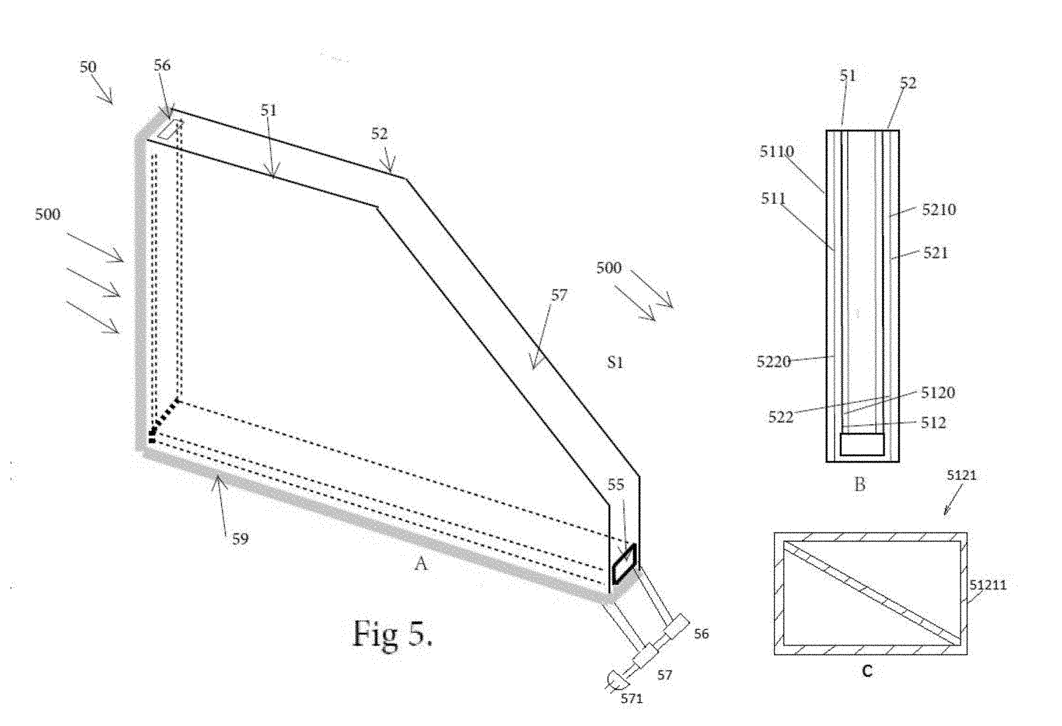

Refer to FIG. 5, an exemplary light adjustable solar energy unit 50 is illustrated in vertical section view. It can be used for roof, wall and windows of a space shell. The carrier material of said absorbing material is an insulating glass 57 having a first glass 51 closer to outside of the space, and second glass 52 closer to interior of the space s1. A spacer 55 closes the surrounding edge of the glasses add form a hollow space 57. The solar energy absorbing materials are: (1) a transparent solar to electricity coating 5110 applied on a surface 511 of the first glass 51. (2) a smart film 5220 based on PDLCs arranged on a surface 521 of the second glass 52. A power supply and control device 56 connects the solar electricity coating 5220 of the smart film for providing the control power. The device 56 may comprise one or more elements selected from a group of following: a battery to store the solar energy, a converter to convert between DC and AC, a transformer to get required voltage, a utility power supply 571 for receiving the generated electricity of the unit and supply utility power if required, a controller with photometer for light control. Usually the two solar energy absorbing materials are applied on the inner sides 512 and 522 of the hollow space of the insulating glass for protection purpose. But the solar to electricity coating and the smart film can also be applied on either one side 511, 512, 521 or 522 of the two sides of the glass according to the local weather situation, the glass type and the weather sensitivity of the solar energy absorbing materials. For example, to arrange the solar to electricity material on the surface directly connect the atmosphere can get more electricity, but less operation time. The smart film on the surface in the hollow space can get more heat, but less operation time. The transparent solar electricity coating usually is more close to sunlight comparing with the smart film. This is a “warm” light self-powered solar energy unit.

In above case, the transparent solar to electricity coating can be replaced or added by a transparent solar thermal material to apply on a surface of the first glass 51. When the replacement is happened, an independent power supply 57 with controller connects the smart film 5220 to provide a controlled electric field. The power supply also can be utility power supply 571 or a separated solar electricity panel (not shown in FIG. 5). When sunlight 500 shines on the unit 50, the solar thermal material (e.g. 5110) will mainly absorb the infrared ray. The smart film controls the “cool” light transmission into the space S1. This is a so called “cool” light adjustable unit mainly used in hot area.

Of cause, the carrier material 51 and 52 can also be one layer of transparent material 51 or three layers of the transparent material (as shown in FIG. 3).

The existing smart film in market may combine many new functions such as color, blocking of UV ray and IR ray. The functions may be caused by intentionally adding new materials to change the functions of PDLCs or by laminating material. The new functions may be also caused by unintentional manufacturing process, such as covering materials for PDLCs, or the cross-linking material 51211 (slash part in FIG. 5 C) for lamination or sealing. From solar energy application point of view, they are not high efficient for use. For example an infrared ray blocked film is not a high efficient product for solar energy saving in cool area. The reason is similar as the reason of low-E glass. Therefore a “pure” smart film is required. The light adjustable solar energy unit may comprise a so called “pure” smart film.

A pure smart film 5121 (as shown in FIG. 5 C) is a film or a laminated element that made of two transparent materials containing PDLCs in between. The sunlight spectrum at two sides of the smart film is as similar as possible. The feature and function of the film is mainly for adjusting sunlight transmission.

For the protection of the PDLCs material, the transparent cover material (e.g. glass and polymer plate or film) can be laminated (e.g. glass) or sealed (e.g. film) along the perimeter edge. To prevent the glass, some net shape cross-liking material 51211 may be added as show in FIG. 5 C. Because not full area of the glass is cross liked, a temperate glass is preferred.

What is claimed is:

1. A high efficient space shell solar energy unit, comprises:
at least two different solar energy absorbing materials for absorb solar energy;
said absorbing materials comprising at least one transparent solar energy absorbing material absorbed solar energy mainly from ultraviolet ray and/or infrared ray of sunlight;
a carrier material for arranging said absorbing materials, comprising at least one transparent carrier material; and said absorbing materials separated by an air gap; and
a fluid channel for transferring absorbed solar heat for use.

2. The unit according to claim 1, further comprises an electricity connecting device for transferring said electricity for use.

3. The unit according to claim 1, wherein said absorbing material comprising a solar cell material converted solar energy to electricity mainly from visible light and comprising semiconductor (e.g. silicon).

4. The unit according to claim 1, wherein said transparent solar energy material comprises a transparent solar to electricity material converted received solar energy to electricity mainly from the Ultraviolet ray and/or infrared ray of the sunlight.

5. The unit according to claim 1, wherein said transparent solar energy absorbing material comprising a transparent solar to thermal material converted received solar energy to thermal mainly from the infrared ray and/or ultraviolet ray of the sunlight.

6. The unit according to claim 1, wherein said absorbing material comprising a material selected from a group of:
a solar cell material converting solar energy to electricity mainly from visible light and comprising a semiconductor;
a solar thermal material of PV cell;
a translucent coating material for low-E glass,
a solar heat absorbing material for heat insulation glass;
a solar thermal material for solar thermal products;
a transparent solar electric coating;
a organic solar energy coat; and
a transparent solar thermal coating.

7. The unit according to claim 1, wherein said absorbing material comprises a smart film based on Polymer Dispersed Liquid Crystals (PDLCs) and required power supply.

8. The unit according to claim 1, wherein said smart film comprises a control device comprising one or more selected from a group of: a photometer, a timer and a controller.

9. The unit according to claim 1, wherein said carrier material is selected from a group of: one transparent carrier material; two carrier materials parallel connected and separated by air gap; three carrier materials parallel connected and separated by air gap.

10. The unit according to claim 1, wherein said carrier material comprising a heat insulating glass.

11. The unit according to claim 1, wherein said carrier material is selected from a group of: a solar PV panel, thin film based on solar cells and an organic solar energy coat.

12. The unit according to claim 1, wherein said carrier material is selected from a group consisting of:
a glass;
a polymer; a film/foil;
a surface of an element of the space shell able receiving sunlight; and
a surface of a transportation device.

13. The unit according to claim 1, wherein said solar electricity connecting device comprising one or more selected from a group of:
a DC/AC converter, a transformer, a photometer and a controller.

14. The unit according to claim 1, wherein said solar fluid channel comprising one or more selected from a group of:
air surround solar thermal absorbing material; a pump;
a gas channel;
a liquid channel;
a fan; and
a controller for transferring said fluid.

15. The unit according to claim 1, wherein said two solar energy absorbing materials are arranged on two sides of a transparent material; and wherein said transparent material is inserted in a slot located in a insulating glass.

16. The unit according to claim 1, comprising a frame in the space shell for receiving said unit, and wherein said unit can be removed from said frame; and wherein said carrier material with solar energy absorbing material can be detached from said unit for replacing and repairing.

17. The unit according to claim 1, wherein said solar absorbing materials and carrier materials are integrated in a form selected from a group of:
a laminated interlayer unit; and
an assumable unit, and said solar absorbing materials and carrier materials separated by separator and air gap.

18. The unit according to claim 1, forms a part of the space; and said space is selected from a group of a building and a transportation device.

19. The unit according to claim 1, further comprising one or more selected from a group of:
a heat insulation material arranged at the back of the unit;
a phase change material arranged under the unit for storing heat and limiting the working temperature of the unit; and
a fluid channel for transferring the absorbed heat.
